(19) United States
(12) Patent Application Publication
(10) Pub. No.: US 2026/0098520 A1
(43) Pub. Date: Apr. 9, 2026

(54) ROTOR STAND

(71) Applicant: LiftWerx Solutions Inc., Cambridge (CA)

(72) Inventors: Glen D. AITKEN, Guelph (CA); Christopher George THOM, Kitchener (CA)

(21) Appl. No.: 19/115,633

(22) PCT Filed: Sep. 26, 2023
(86) PCT No.: PCT/CA2023/051269

§ 371 Date: Mar. 26, 2025

Related U.S. Application Data
(60) Provisional application No. 63/410,331, filed on Sep. 27, 2022.

(51) Int. Cl. F03D 80/50; B25H 1/00; F16M 11/22

(52) U.S. Cl. CPC F03D 80/50; B25H 1/0021; F16M 11/22

(57) ABSTRACT

A rotor stand for a wind turbine rotor includes: an interface plate configured to secure thereto a rotor hub of the wind turbine rotor; a plurality of legs connected to and extending radially outward from the interface plate, at least one of the legs radially extendible to permit changing a length of the extendible leg; and, a plurality of support shoes connected to the plurality of legs, the support shoes configured to support the rotor stand on a horizontal surface with the interface plate oriented substantially parallel to the horizontal surface.

### CROSS-REFERENCE TO RELATED APPLICATIONS

This application claims the benefit of United States Provisional Patent Application U.S. Ser. No. 63/410,331 filed Sep. 27, 2022, the entire contents of which is herein incorporated by reference.

### FIELD

This application relates to wind turbines, in particular to a stand for supporting a wind turbine rotor on a surface such as the ground.

### BACKGROUND

A wind turbine comprises a tower atop which is situated a rotor. The rotor comprises a rotor hub and one or more rotor blades attached to the rotor hub, which are usually symmetrically disposed around a central point of the rotor hub. The rotor hub is attached to a rotatable main shaft, which is attached to a generator that produces electricity as the main shaft is rotated by rotation of the rotor hub, the rotor hub being rotatably driven by the action of wind on rotor blades. The main shaft and the generator are housed in a nacelle that sits on top of the tower.

When the rotor requires servicing, it is usually necessary to dismount the rotor from the main shaft and lower the rotor to the ground, for example by the use of one or more lifting devices. The rotor may be lowered as one piece by dismounting the rotor hub from the main shaft and then lowering the entire rotor. Or, each of the rotor blades and then the rotor hub in turn may be dismounted, and each piece lowered one at a time as they are dismounted. Lowering pieces of the rotor one at a time has the advantage of requiring a less robust lift system, but the disadvantages of being more time consuming and more dangerous for workers since the workers must spend more time up-tower dismounting several pieces rather than just the rotor hub from the main shaft. It is therefore preferable in many circumstances to be able to dismount and lower the entire rotor all at once, and then dismount the rotor blades from the rotor hub once the rotor is resting at ground level.

When the rotor is at ground level, the rotor is often supported on the ground through the rotor hub. To avoid damage to the rotor hub, the rotor may be supported on a rotor support. With the rotor blades symmetrically disposed around the rotor hub, the rotor is balanced and the rotor blades do not contact the ground or other surface. However, fully-assembled rotors are huge in diameter with the rotor blades extending a great distance away from the rotor hub. When one of the rotor blades is removed, the rotor becomes unbalanced and tips in one direction. While the rotor hub is usually secured to a rotor stand, tipping of the rotor once the rotor blade is removed puts great strain on the rotor hub and the fasteners used to secure the rotor hub to the stand. The strain can damage the fasteners and/or the rotor hub, which can also result in tipping of the rotor such that one or more of the remaining rotor blades contacts that ground causing even more damage.

Thus, there remains a need for a versatile rotor stand that can be adjusted to accommodate and stabilize many sizes of rotor, and stabilize the rotor in a horizontal orientation when any number of rotor blades is to be removed from the rotor hub in a servicing operation.

### SUMMARY

A rotor stand for a wind turbine rotor comprises: an interface plate configured to secure thereto a rotor hub of the wind turbine rotor; a plurality of legs connected to and extending radially outward from the interface plate, at least one of the legs radially extendible to permit changing a length of the extendible leg; and, a plurality of support shoes connected to the plurality of legs, the support shoes configured to support the rotor stand on a horizontal surface with the interface plate oriented substantially parallel to the horizontal surface.

A rotor of a wind turbine comprises a rotor hub that is connectable to a main shaft of the wind turbine and one or more rotor blades, for example three rotor blades, that are attached to the rotor hub, preferably symmetrically around the rotor hub.

The stand comprises the interface plate on which and to which the rotor hub may be supported and secured. Securing the rotor hub to the interface plate can be accomplished by any suitable means, for example with clamps, pins (e.g., bolts) and the like. Preferably, the rotor hub is secured to the interface plate such that securement forces are symmetrically distributed around the rotor hub to minimize the possibility of damage to the rotor hub, especially in windy conditions. In some embodiments, the interface plate comprises a plurality of interface apertures, preferably through-apertures through opposed faces of the interface plate, arranged to align with a plurality of rotor hub mounting apertures of the rotor hub. The rotor hub is therefore supportable on the interface plate and securable to the interface by at least one fastener (for example, clamps, pins (e.g., bolts) and the like) inserted into at least one of the plurality of interface apertures and into at least one of the aligned rotor hub mounting apertures. Preferably, at least four of the interface apertures and a corresponding four of the rotor hub mounting apertures are employed for securement of the rotor hub to the interface plate.

The plurality of legs is connected to and extending radially outward from the interface plate. Preferably, the plurality of legs comprises two or more legs, in some embodiments four or more legs, for example 2, 3, 4, 5, 6, 7, 8 or more legs. In some embodiments, the plurality of legs comprises four legs are preferably symmetrically arranged around the interface plate to provide better stability and balance to the stand. At least one of the legs is radially extendible to permit changing a length of the extendible leg. Preferably, all of the legs are radially extendible. Radial extendibility of the legs may be accomplished in any suitable manner, for example with telescoping leg sections, with foldable leg sections, by adding leg inserts or combinations thereof. Radial extendibility of the legs increases effective lengths of the legs.

In some embodiments, an extendible leg comprises a foldable leg. The foldable leg comprises an immovable portion connected to the interface plate and an extension section pivotally connected to the immovable portion, preferably a distal end of the immovable portion. The extension section is pivotable from a folded stored position, preferably folded up and/or folded in, to a radially extended deployed position. In the deployed position, a distal end of the extension section is radially farther from the interface plate than the distal end of the immovable section. In some embodiments, an extendible leg comprises a leg insert removably connectable to and between the interface plate and one of the plurality of legs. In some embodiments, an extendible leg comprises both the pivotable extension section and the leg insert. Preferably all of the plurality of legs are extendible legs.

In some embodiments, the immovable portion comprises a lower leg portion resting on the horizontal surface, an angled upper leg portion and a vertical leg portion. The upper leg portion is connected to the lower leg portion at distal ends thereof. A proximal end of the upper leg portion is connected to a top of the vertical leg portion. A proximal end of the lower leg portion is connected to a bottom of the vertical leg portion. The interface place is supported on the top of the vertical leg portion. The immovable portion thereby comprises a right-angled bracket resting on the horizontal surface on which the interface place is supported.

In some embodiments, the stand further comprises a base configured to rest on the horizontal surface. The base is preferably situated underneath and spaced-apart vertically from the interface plate. The base is preferably connectable to the plurality of legs to provide stability and structural strength to the stand. In some embodiments, the base comprising a plurality of arms extending radially outward from a center of the base. In some embodiments, the plurality of arms are connected to respective legs of the plurality of legs such that each arm is connected to the immovable portion of a foldable leg or to a proximal end of a leg insert. In some embodiments, the immovable portion of the foldable leg is connected to one of the arms of the base at the proximal end of the lower leg portion and the bottom of the vertical leg portion of the immovable portion.

The support shoes connected to the extendible legs are preferably removably connected. Thus, the support shoes are connected to distal ends of the immovable portions of the legs when the extension sections are in the stored positions but to the distal ends of the extension sections when the extension sections are in the deployed positions. Thus, the same support shoes may be used whether the legs are extended or not, thereby reducing the number of parts required for the stand. In some embodiments, a plurality of anchors may be provided for anchoring the plurality of support shoes to the horizontal surface, thereby providing better stability for the stand, particularly in windy conditions. The anchors may comprise slings with shackles attached to nearby heavy equipment such as cranes and forklifts.

In some embodiments, all or some of the connections are accomplished with removable pins so that the stand comprises modular components. The stand can then be disassembled and the components packed on a skid for transport from site to site. Preferably, the stand can be dissembled into the following components: the interface plate, the base, the immovable portions of the legs, the extension sections of the legs; the support shoes; and the pins that connect all of the components.

The rotor stand is particularly useful for temporary storage of the rotor, for example as a temporary support to permit removal of the rotor blades from the rotor hub or attachment of the rotor blades to the rotor hub. The rotor stand is configurable to support both balanced loads and unbalanced loads. When the rotor comprises all of the rotor blades, the center of gravity of the rotor is at about the center of the rotor hub and the rotor is a balanced load when the rotor hub is supported on the rotor stand. However, if one or more of the rotor blades is removed, the rotor will be unbalanced as the center of gravity moves away from the rotor hub and the weight supported by at least one of the support shoes becomes substantially different than the weight supported by the other support shoes. To support an unbalanced load, one or more of the legs is extended horizontally so that weight of the rotor is more evenly distributed over all of the support shoes.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1A depicts a rotor stand with all legs thereof in a compact configuration.

FIG. 1B depicts the rotor stand of FIG. 1A from a different perspective.

FIG. 1C depicts the rotor stand of FIG. 1A with a rotor supported thereon, the rotor having three symmetrically arranged rotor blades attached to a rotor hub.

FIG. 1D depicts a magnified view of the rotor stand of FIG. 1C.

FIG. 2A depicts the rotor stand of FIG. 1A with leg extensions of two of the legs deployed.

FIG. 2B depicts the rotor stand of FIG. 1B from a different perspective.

FIG. 2C depicts the rotor stand of FIG. 2A with the rotor supported thereon, the rotor having only two of the three rotor blades attached to the rotor hub.

FIG. 2D depicts a magnified view of the rotor stand of FIG. 2C.

FIG. 3A depicts the rotor stand of FIG. 1A with leg extension of all of the legs deployed.

FIG. 3B depicts the rotor stand of FIG. 3B from a different perspective.

FIG. 3C depicts the rotor stand of FIG. 3A with the rotor supported thereon, the rotor having only one of the three rotor blades attached to the rotor hub.

FIG. 3D depicts a magnified view of the rotor stand of FIG. 3C.

FIG. 4A depicts the rotor stand of FIG. 1A with leg inserts included for all of the legs.

FIG. 4B depicts the rotor stand of FIG. 4B from a different perspective.

FIG. 4C depicts the rotor stand of FIG. 4A with the rotor supported thereon, the rotor having only two of the three rotor blades attached to the rotor hub.

FIG. 4D depicts a magnified view of the rotor stand of FIG. 4C.

FIG. 5A depicts a shipping skid for the rotor stand of FIG. 1A.

FIG. 5B depicts the shipping skid of FIG. 5A with all of parts of the rotor stand mounted thereon.

FIG. 5C depicts the shipping skid of FIG. 5B with the parts of the rotor stand shown in exploded view.

### DETAILED DESCRIPTION

Referring to the Figures, one embodiment of a rotor stand 1 for a wind turbine rotor 100 comprises an interface plate 3 on which a rotor hub 101 is supported when the rotor 100 is supported on the stand 1. In the illustrated embodiment, the rotor 100 comprises three rotor blades 102, including a first rotor blade 102a, a second rotor blade 102b and a third rotor blade 102c connected to and symmetrically situated around the hub 101. The interface plate 3 comprises a plurality of threaded interface through-apertures 5 (only one labeled) through opposed faces of the interface plate 3 and arranged to align with a plurality of threaded rotor hub mounting apertures (not shown) on the hub 101. In the illustrated embodiment, the rotor hub mounting apertures are arranged as a ring of apertures in a face of the hub 101 which permit mounting the hub 101 to a main shaft of the wind turbine. Therefore, the threaded through-apertures 5 are arranged in a corresponding circle. However, the threaded through-apertures 5 may be arranged in any pattern provided at least one, preferably more than one, of the threaded through-apertures 5 can be aligned with at least one, preferably more than one, of the rotor hub mounting apertures. Preferably, at least four of the threaded through-apertures 5 can be aligned with at least four of the rotor hub mounting apertures, whereby the four threaded through-apertures 5 are symmetrically situated around the circle of through-apertures 5 in order to evenly distribute securement forces around the hub 101. To support the rotor 100 on the stand 1, the rotor 100 is usually lowered by a lifting device (e.g., a crane) so that the face of the hub 101 is on the interface plate 3 and fasteners (e.g., pins (for example bolts), clamps and the like) are inserted through at least one, preferably more than one, more preferably at least four, of the through-apertures 5 and the corresponding hub mounting apertures to secure the rotor 100 to the stand 1. The interface plate 3 preferably comprises raised portions 7 (only one labeled) on which the hub 101 rests to provide a gap between the hub 101 and non-raised portions of the interface plate 3.

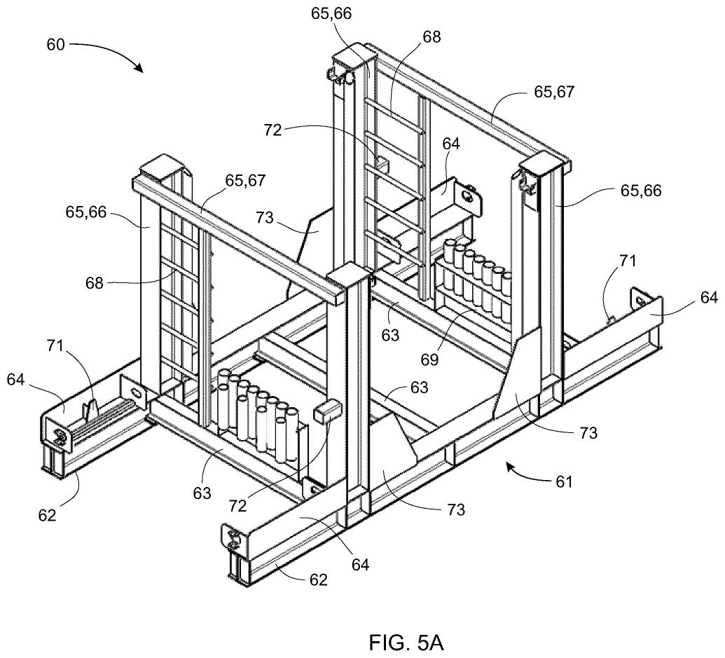

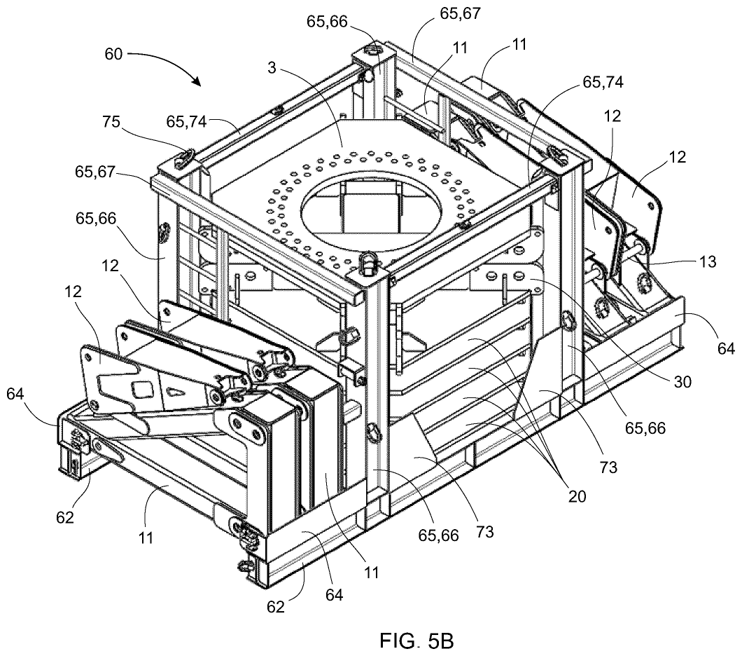

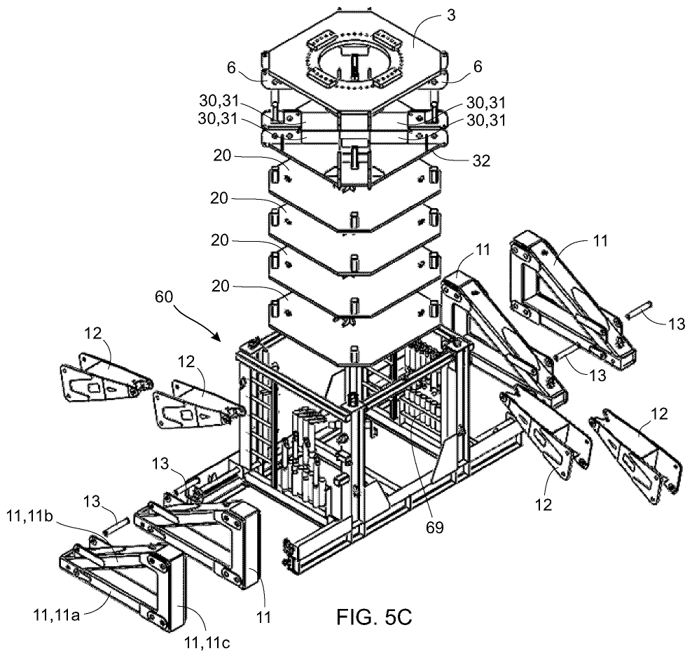

The stand 1 comprises four foldable legs 10, each of the legs 10 comprising an immovable portion 11 and an extension section 12 pivotally connected to a distal end of the immovable portion 11. The immovable portion 11 comprises a triangular frame (see FIG. 5C) having a lower leg portion 11a resting on the ground or other horizontal surface, an angled upper leg portion 11b and a vertical leg portion 11c, all connected in a right-angle triangle. The upper leg portion 11b is connected to the lower leg portion 11a at distal ends thereof. A proximal end of the upper leg portion 11b is connected to a top of the vertical leg portion 11c. A proximal end of the lower leg portion 11b is connected to a bottom of the vertical leg portion 11c. The extension section 12 of the leg 10 is pivotally connected to the distal end of the immovable portion 11 by a pivot pin 13 to enable an increase in effective leg length by folding out the extension section 12 to thereby deploy the extension section 12. The interface plate 3 is supported on the tops of the vertical leg portions 11c. of the legs 10 and is pinned to the vertical leg portions 11c and to the upper leg portions 11b by a pair of interface plate pins 8 to connect both the vertical leg portions 11c and the upper leg portions 11b to interface plate brackets 6 attached to an underside of the interface plate 3 at corners thereof.

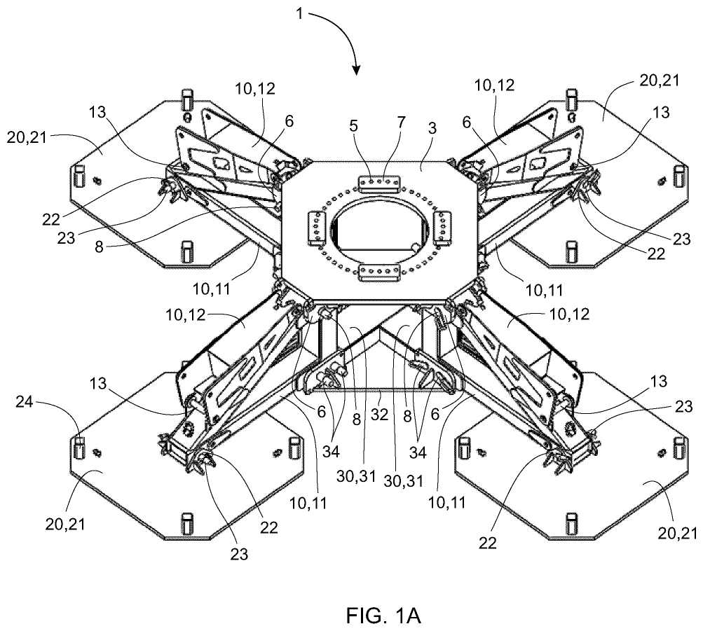

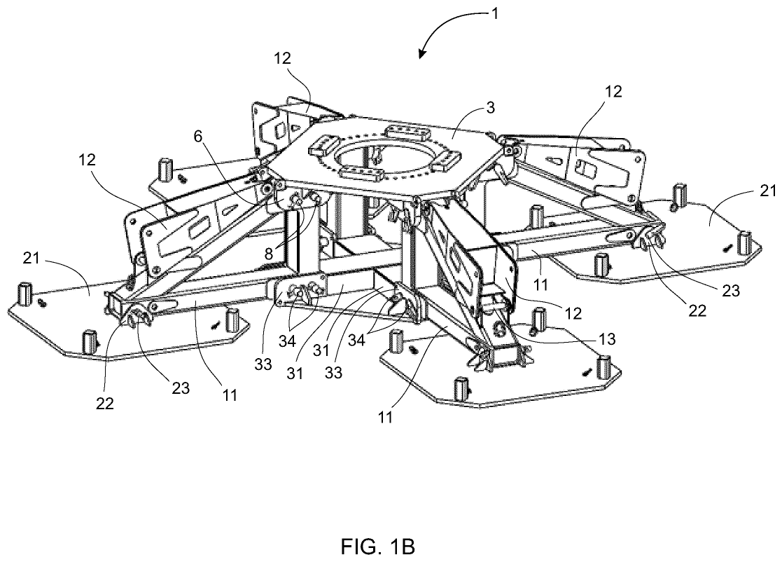

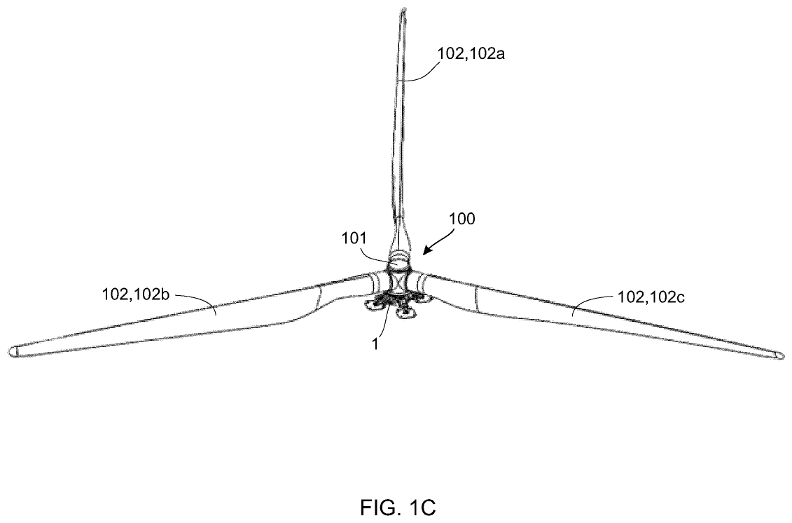

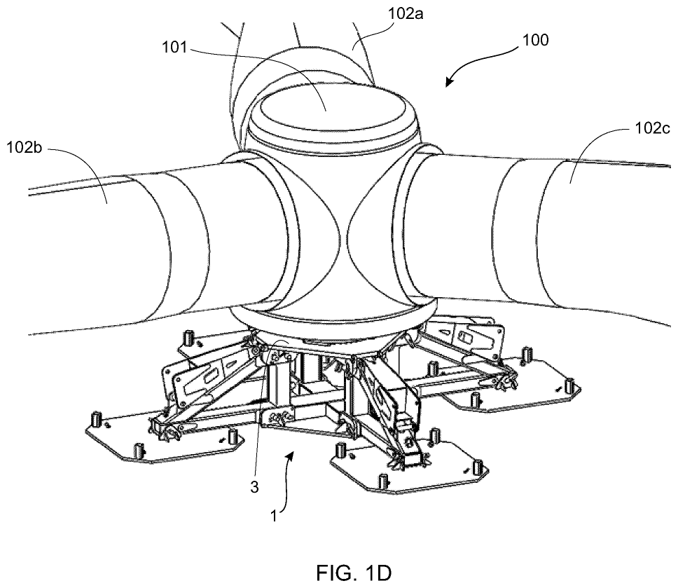

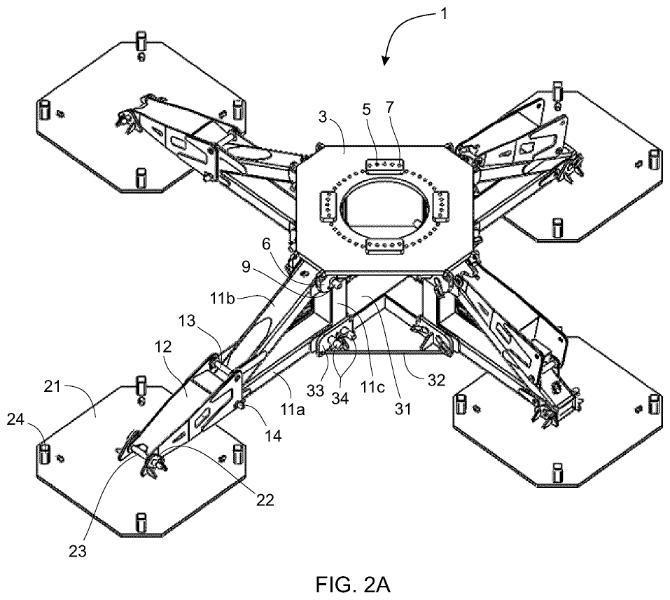

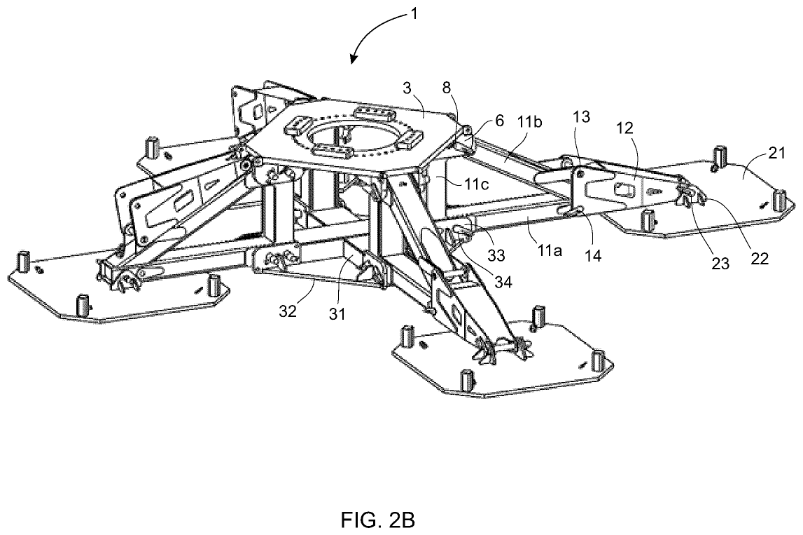

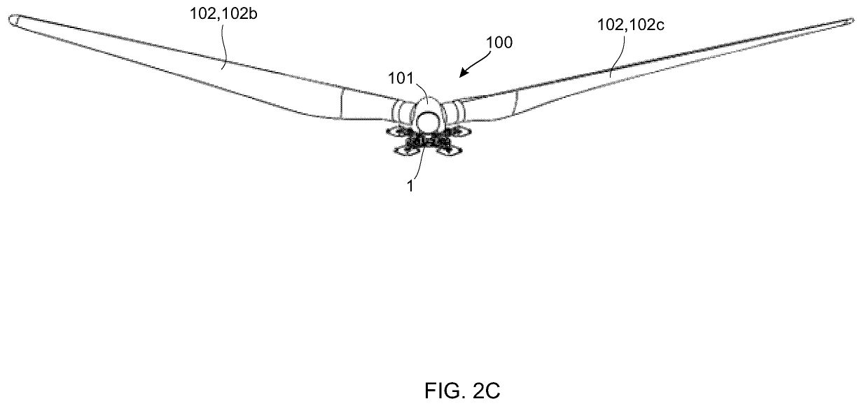

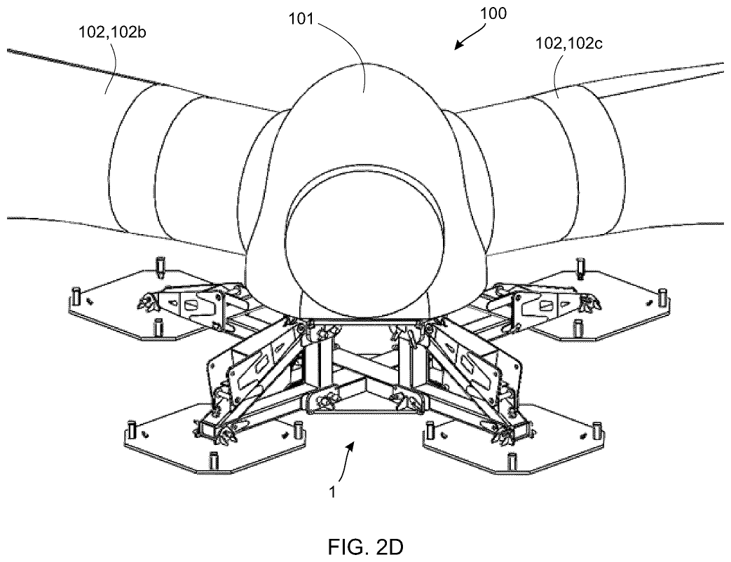

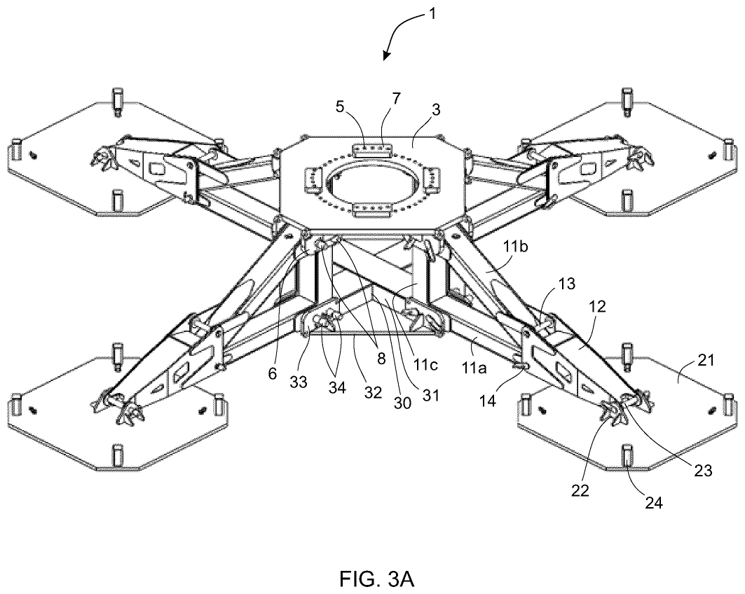

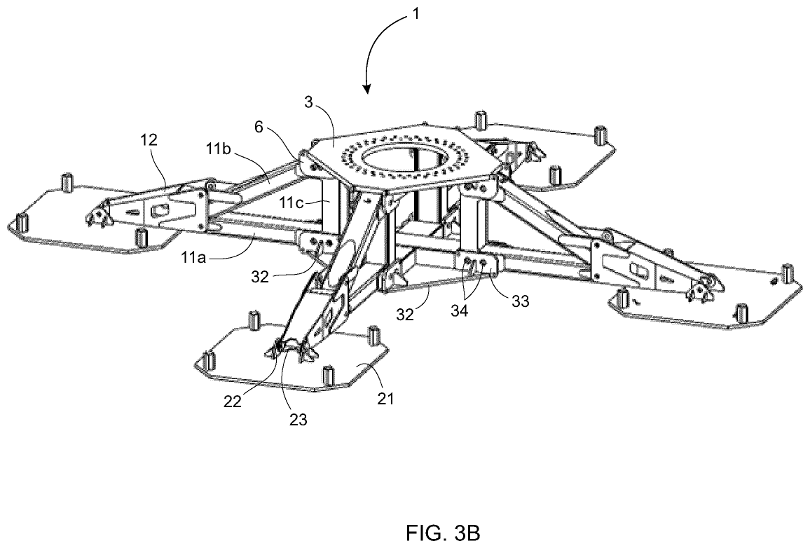

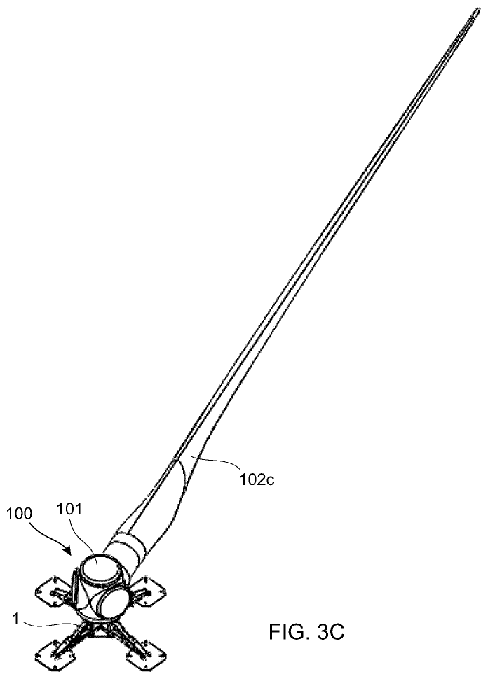

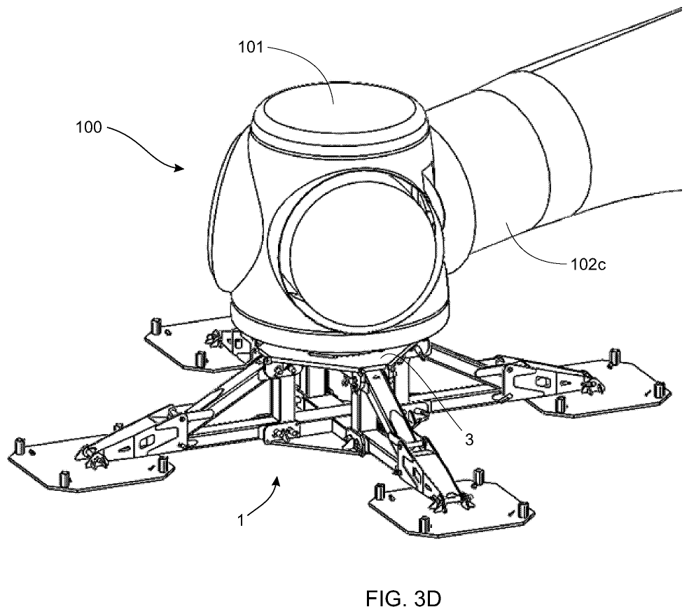

The stand 1 is supported on the ground or other horizontal surface by support shoes 20 connected to the legs 10. Each of the support shoes 20 comprises a ground-engaging plate 21 having a mounting bracket 22 on a top face of the ground-engaging plate 21, preferably centrally located on the ground-engaging plate 21, the leg 10 connected to the mounting bracket 22 by a shoe mounting pin 23. When the extension section 12 is folded in a stored position, as seen for all of the legs 10 in FIG. 1A to FIG. 1D, the support shoe 20 is connected to the distal end of the immovable portion 11 of the leg 10. When the extension section 12 is folded out in a deployed position, as seen for all of the legs 10 in FIG. 3A to FIG. 3D, the support shoe 20 is connected to the distal end of the extension section 12 of the leg 10. The extension section 12 is locked in the deployed position by an extension section securement pin 14 (se FIG. 2A) to prevent pivoting of the extension section 12 when the stand 1 is being used. If the horizontal surface on which the stand 1 is supported is uneven, the horizontal surface is preferably leveled or resilient mats placed under the stand 1 to help level the stand 1. The support shoes 20 are preferably provided with pipe supports 24 (only one labeled), which aid in stacking of the ground-engaging plates 21 when stored in a shipping skid.

The stand 1 further comprises a base 30 situated underneath and spaced-apart vertically from the interface plate 3. The base 30 comprises four arms 31 extending radially outward from a center, the four arms 31 each perpendicular to adjacent arms and colinear with an opposite arm to form a ‘cross-shaped’ structure that rests on the ground or other horizontal surface underneath the interface plate 3. Distal ends of adjacent arms 31 are connected by ties 32 to provide stability and structural strength to the base 30. Distal ends of each of the arms 31 comprise leg brackets 33 that receive the legs 10 where the lower leg portion 11a is connected to the vertical leg portion 11c. The legs 10 are secured in the leg brackets 33 by leg pins 34.

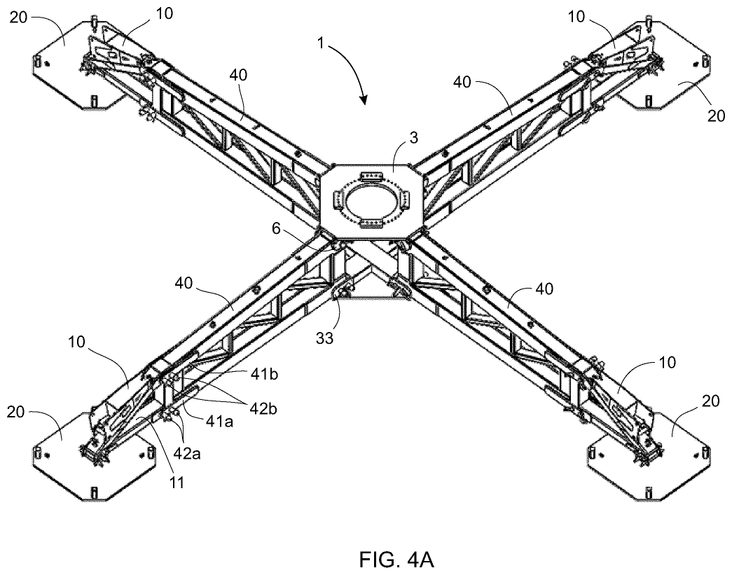

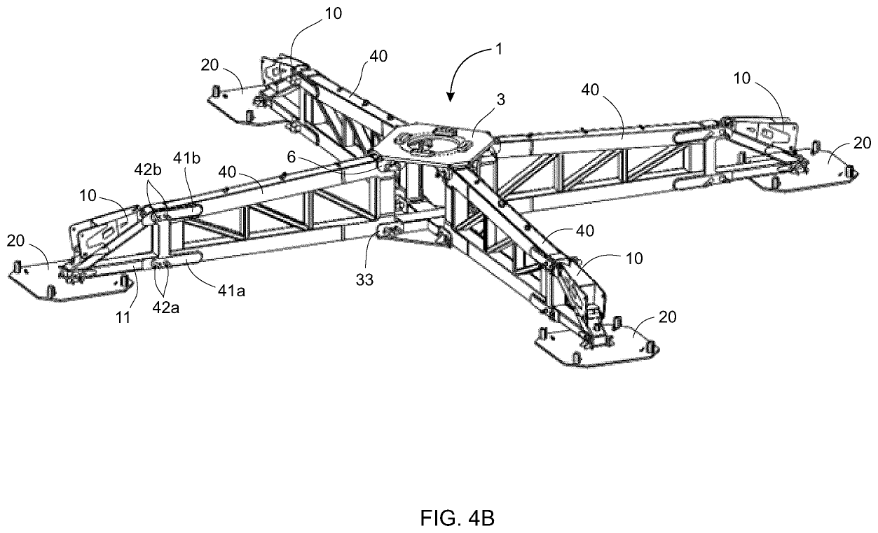

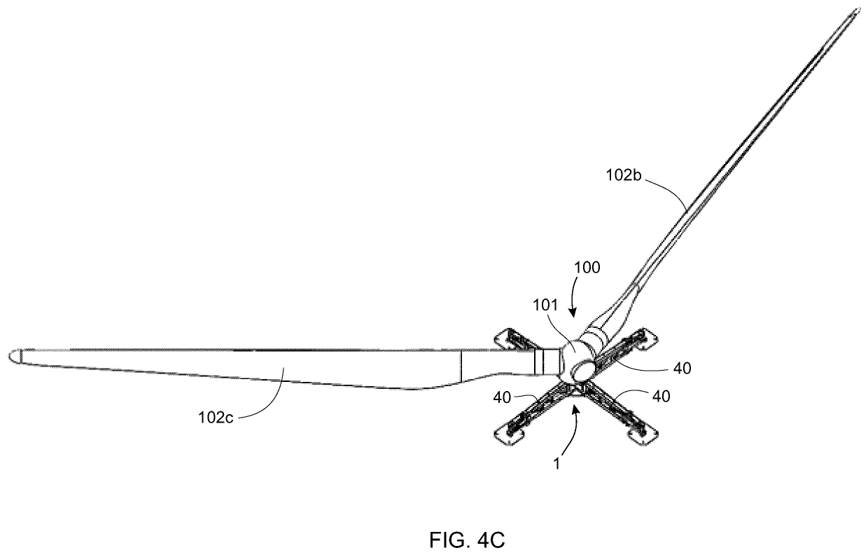

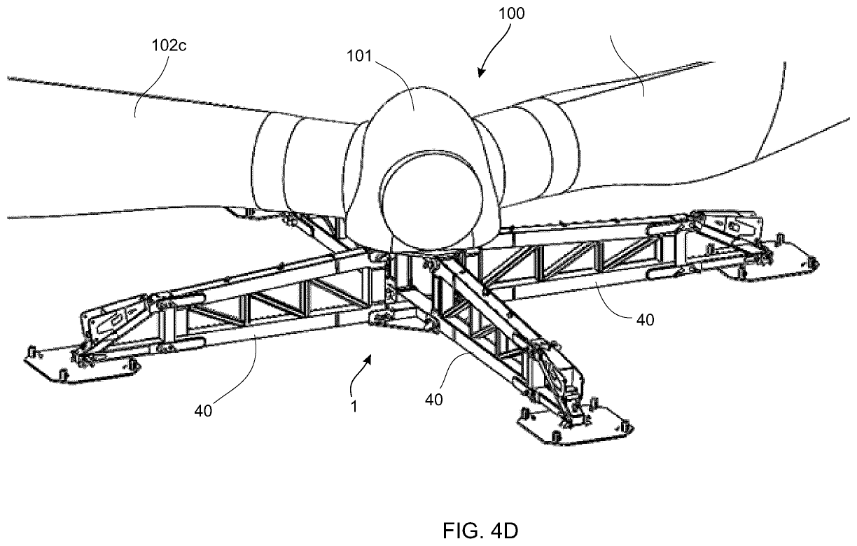

As seen in FIG. 4A to FIG. 4D, effective lengths of the legs 10 can be increased even further using leg inserts 40 situated between the interface plate 3 and the legs 10. Each leg insert 40 is a linear truss having a proximal end and a distal end. The proximal end of the leg insert 40 is connectable to a leg bracket 33 of the base 30 and supports the interface plate 3 in the same manner as described above for the leg 10. The distal end of the leg insert 40 comprises lower and upper insert brackets 41a, 41b, respectively, which are connectable to the leg 10 by lower and upper pins 42a, 42b, respectively. Thus, the proximal end of the leg insert 40 is configured similarly to the proximal end of the leg 10, And, the distal end of the leg insert 40 is configured at the lower portion similarly to the arms 31 of the base 30 and at the upper portion similarly to the interface plate brackets 6.

FIG. 1A to FIG. 1D depict a standard configuration in which all of the foldable legs 10 have respective extension sections 12 folded in the stored position. The standard configuration is used for supporting balanced loads where the rotor 100 is up to 50 meters in radius, where the radius is measured from a center point of the hub 101 to tips of the rotor blades 102.

FIG. 2A to FIG. 2D depict a configuration in which two of the foldable legs 10 have respective extension sections 12 folded in the stored position while an opposite two of the foldable legs 10 have respective extension sections 12 folded out in the deployed position. The legs 10 with deployed extension sections 12 are on an opposite side of the interface plate 3 from the legs 10 with the stored extension sections 12. The configuration shown in FIG. 2A to FIG. 2D is used for supporting unbalanced loads where the rotor 100 is up to 50 meters in radius for the removal of one of the rotor blades 102. The configuration shown in FIG. 2A to FIG. 2D is particularly useful when one of the rotor blades 102 is to be removed. The two extended legs are on the same side of the interface plate 3 as the remaining rotor blades 102b, 102c, compensating for the change in the center of gravity of the rotor 100 when the rotor blade 102a is removed so that the stand 1 does not tip over.

FIG. 3A to FIG. 3D depict a configuration in which all of the foldable legs 10 have respective extension sections 12 folded out in the deployed position. The configuration shown in FIG. 3A to FIG. 3D is used for supporting unbalanced loads where the rotor 100 is up to 50 meters in radius for the removal of two or three of the rotor blades 102. Extending all four legs 10 compensates for the change in the center of gravity of the rotor 100 when the rotor blades 102a and 102b are removed so that the stand 1 does not tip over.

When used with rotors 100 of up to 50 meters in radius, the rotor stand 1 is stable in winds gusting up to 15 m/s. With winds gusting up to 15 m/s, no secondary supports or anchors are required. With winds gusting to greater than 15 m/s, the rotor stand 1 may be anchored to the ground or a secondary support for greater stability.

FIG. 4A to FIG. 4D depicts a configuration of the rotor stand 1 for supporting loads where the rotor 100 is greater than 50 meters in radius. Folding out the leg extensions 12 can be done, if desired, as described with reference to FIG. 2A to FIG. 2D and FIG. 3A to FIG. 3D.

With reference to FIG. 5A to FIG. 5C, because the rotor stand 1 is modular where various components are releasably pinned together, the rotor stand 1 can be disassembled quickly and efficiently and packed in a shipping skid 60 for transportation to and from a work site. The shipping skid 60 comprises a skid base 61 having a pair of parallel, spaced-apart rails 62 that support the skid 60 on a horizontal surface. The rails 62 are connected together by three parallel, spaced-apart elongated bars 63 extending between the rails 62 and oriented perpendicular to the rails 62. End portions of the rails 62 are provided with containment brackets 64 that help contain the immovable portions 11 and the extension sections 12 of the legs 10 supported on the end portions of the rails 62. The pivot pins 13 can be used to help secure the immovable portions 11 and the extension sections 12 of the legs 10 in the containment brackets 64. Separators 71 attached to the containment brackets 64 separate adjacent legs 10 that are supported in the containment brackets 64 on the rails 62 at a given end of the rails 62 in order to prevent the adjacent legs 10 from jostling each other during transport.

Situated proximate the outermost of the bars 63 are upwardly extending support frames 65, each support frame 65 having a pair of upwardly extending struts 66 connected at bottoms thereof to the rails 62, a crosspiece 67 connecting the struts 66 at tops thereof and an elongated retaining member 74 connecting the struts 66 at tops thereof in a direction perpendicular to the crosspiece 67. Gussets 73 between the struts 66 and the rails 62 provide structural strength for the struts 66. Pin holders 69 (only one shown and labeled) are supported on the outermost of the bars 63, various pins associated with the stand 1 being contained in the pin holders 69. The frames 65 comprises ladders 68 that can be used by workers to climb to the top of the frames 65 to assist with packing flat components (i.e., the interface plate 3 and the support shoes 20) of the stand 1 on the skid 60. Spacers 72 extending from the struts 66 abut innermost legs 10 that are supported in the containment brackets 64 on the rails 62 at a given end of the rails 62 in order to prevent the innermost legs 10 from moving during transport. A plurality of lifting rings 75 (only one labeled) are situated in various position on the skid 60 so that the skid 60 can be attached to a lifting device (e.g., a crane) for moving about a work site.

The components of the stand 1 are packed on this skid 60 such that, with the elongated retaining members 74 removed, the support shoes 20 are stacked between the frames 65. The base 30 of the stand 1 and then the interface plate 3 are stacked on top of the stack of support shoes 20 between the frames 65. The elongated retaining members 74 are then connected in the struts 66. The elongated retaining members 74 are positioned to contact the edges of the interface plate 3 to prevent the interface plate 3 from escaping out the top of the frame 65. The immovable portions 11 of the legs 10 are supported on the end portions of the rails 62 in the containment brackets 64, two immovable portions 11 at each end of the rails 62. The extension sections 12 rest on top of and are pinned to corresponding immovable portions 11. Most of the pins are retained in the pin holders 69 with some of the pins used to help secure the legs 10 in the skid 60.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. A rotor stand for a wind turbine rotor, the rotor stand comprising:
an interface plate configured to secure thereto a rotor hub of the wind turbine rotor;
a plurality of legs connected to and extending radially outward from the interface plate, at least one of the legs radially extendible to permit changing a length of the extendible leg; and,
a plurality of support shoes connected to the plurality of legs, the support shoes configured to support the rotor stand on a horizontal surface with the interface plate oriented substantially parallel to the horizontal surface.

2. The stand of claim 1, wherein the interface plate comprises a plurality of interface apertures arranged to align with a plurality of rotor hub mounting apertures of the rotor hub, the rotor hub supportable on the interface plate and securable to the interface by at least one fastener inserted into at least one of the plurality of interface apertures and into at least one of the aligned rotor hub mounting apertures.

3. The stand of claim 2, wherein the plurality of interface apertures are through-apertures.

4. The stand of claim 1, wherein each of the at least one extendible leg comprises a foldable leg comprising an immovable portion connected to the interface plate and an extension section pivotally connected to a distal end of the immovable portion, whereby the extension section is pivotable from a folded stored position to a radially extended deployed position whereby a distal end of the extension section is radially farther from the interface plate than the distal end of the immovable section.

5. The stand of claim 4, wherein the support shoe connected to the extendible leg is removably connected so that the support shoe is connected to a distal end of the immovable portion when the extension section is in the stored position but to the distal end of the extension section when the extension section is in the deployed position.

6. The stand of claim 4, wherein the immovable portion comprises a lower leg portion resting on the horizontal surface, an angled upper leg portion and a vertical leg portion, whereby:
the upper leg portion is connected to the lower leg portion at distal ends thereof;
a proximal end of the upper leg portion is connected to a top of the vertical leg portion;
a proximal end of the lower leg portion is connected to a bottom of the vertical leg portion; and,
the interface place is supported on the top of the vertical leg portion.

7. The stand of claim 6, further comprising a base configured to rest on the horizontal surface underneath and spaced-apart vertically from the interface plate, the base comprising a plurality of arms extending radially outward from a center of the base, the plurality of arms connected to the plurality of legs such that the foldable leg is connected to one of the arms at the proximal end of the lower leg portion and the bottom of the vertical leg portion.

8. The stand of claim 1, wherein all of the plurality of legs are radially extendible.

9. The stand of claim 1, wherein the plurality of legs are four legs connected to and symmetrically arranged around the interface plate.

10. The stand of claim 1, further comprising a plurality of leg inserts removably connectable to and between the interface plate and respective legs of the plurality of legs to increase effective lengths of the legs.

11. The stand of claim 1, further comprising a plurality of anchors for anchoring the plurality of support shoes to the horizontal surface.

12. The stand of claim 1, wherein all connections are accomplished with removable pins so that the stand comprises modular components for disassembly and packing on a skid.
